(19) United States
(12) Patent Application Publication
(10) Pub. No.: US 2013/0047498 A1
(43) Pub. Date: Feb. 28, 2013

(54) Disposable Insect Capturing Device Having An Extendable Handle

(71) Applicant: Donald Eugene Keim, JR., Wyomissing, PA (US)

(72) Inventor: Donald Eugene Keim, JR., Wyomissing, PA (US)

(21) Appl. No.: 13/527,804

(22) Filed: Jun. 20, 2012

Related U.S. Application Data
(60) Provisional application No. 61/573,103, filed on Aug. 31, 2011.

(51) Int. Cl. A01M 3/04

(52) U.S. Cl. 43/136

(57) ABSTRACT

A device suited for the capture of insects and for the retrieval of small objects is disclosed. In a preferred embodiment, the device is comprised of a strip of foam material formed into an teardrop shape that has a tacky adhesive on an area of the strip's outer side. In use, this tacky adhesive is placed against an insect or object, thereby reversibly affixing the insect or object to the strip. Other embodiments include a handle of fixed, or telescoping length, that can hold the strip of foam material so that more distal insects and objects can be affixed to the material and drawn back to the user.

### REFERENCE TO RELATED APPLICATION

This non-provisional application claims the benefit of U.S. Provisional Patent Application No. 61/573,103, filed on or about Aug. 31, 2011 entitled “Disposable Insect Capturing Device Having An Extendable Handle” and naming the same inventor as in the present application. The contents of this provisional application is incorporated by reference in its entirety.

### FIELD OF THE INVENTION

The subject matter of this application relates to devices used to reach and retrieve (or in the case of insects, capture) objects that are either out of reach of a person, or objects that a user would rather avoid directly touching.

### BACKGROUND

Although it is legend that Johnny Appleseed once put out his fire to keep insects from flying into it and dying, that is an anomaly, and many people would prefer if they never had to encounter an insect. Even people that appreciate the necessary place in our ecosystem that insects occupy still usually don't want insects crawling around inside their house.

The elimination of insects can be done simply by swatting them with an open palm, but most people prefer to avoid doing that for several reasons. Among these reasons are that it's unpleasant and unsanitary to have a hand coated in insect guts; the dead insect may fall after being struck, further polluting the area; the squished insect may leave behind a smear on the wall or other structure it was pressed against; and, stinging insects might be oriented in such a way that striking them causes injury to the person. Further, there is the possibly irrational fear that an insect might be missed or merely injured after being struck, leaving a insect bent on revenge, waiting for their assailant to drop his guard. More practically, striking a wall or other structure with a bare hand can be injurious to the person if a splinter or other sharp protrusion is encountered.

Some of the prior art has attempted to address these concerns by employing a sticky adhesive to capture the insect. The following are offered as examples of this art.

U.S. Pat. No. 6,067,746 discloses a flat plate on which an adhesive sheet is attached and that is attached to an elongated handle. When pressed against an insect, that insect becomes stuck to the adhesive paper and further trapped by a foldable cover member.

U.S. Pat. No. 6,185,862 discloses a pad of adhesive coated sheets wherein sheets may be peeled off the pad and used to manually grasp insects. The sheets are collapsible so that the sheets partially conform to the captured insect's body. Further, this pad may be attached to a handle for the capture of more distal insects.

U.S. Pat. No. 6,564,505 discloses an article retrieving tool that includes a means for attaching a pad of adhesive coated sheets that may be used to capture insects.

U.S. Pat. No. 6,651,379 discloses a pad of collapsible sheets, each having an adhesive area that can be used to capture insects. The sheets partially conforms to the body of the captured insect. This pad may also be attached to a handle.

U.S. Pat. No. 6,877,273 discloses a multi-position handle that, inter alia, holds a pad of adhesive sheets that may be used to capture insects.

U.S. Pat. No. 7,065,919 discloses an insect capture device wherein flaps close around an insect to trap it. One or both of these flaps is coated with a sticky adhesive material.

U.S. Pat. No. 7,676,986 discloses another compressible, adhesive sheet that is used to grab insects in a way wherein the sheet partially conforms to the insects's body.

Although these inventions may be useful for capturing insects, there still exists the possibility of the insect being squished against the object it is sitting on, especially when capturing the insect requires the use of an handle, such as a fly swatter, to strike the insect where it sits. Another issue is that the disclosed adhesive sheets can become stuck to the surface they are pressed against to capture the insect. Further, the mentioned prior art that employs hand-held adhesive sheets requires the user's hand to be in very close proximity to the insect, something many people find repulsive.

### SUMMARY

The subject matter of this application is suited for the capture of insects and for the retrieval of small objects. An object of the invention is to provide a device for capturing live or dead insects using an adhesive in a way that minimizes the possibility of the adhesive contacting the area surrounding the insect. Another object of the invention is minimize the possibility of the insect being crushed by the device. Yet another object of the invention is to provide for a device that can be used in close quarters without the need for the user's fingertips to be within several millimeters of the target insect. In a preferred embodiment, an additional object of the invention is to provide for an insect capturing device that can be used when the target insect is out of the reach of the user though the use of a handle that reversibly attaches to the device.

In that embodiment, the device and handle are separable via the force of gravity, eliminating the need for the user to touch either the insect itself, or the insect capture device.

### BRIEF DESCRIPTION OF THE DRAWINGS

FIG. 1 is a perspective view of a preferred embodiment of the insect capture device.

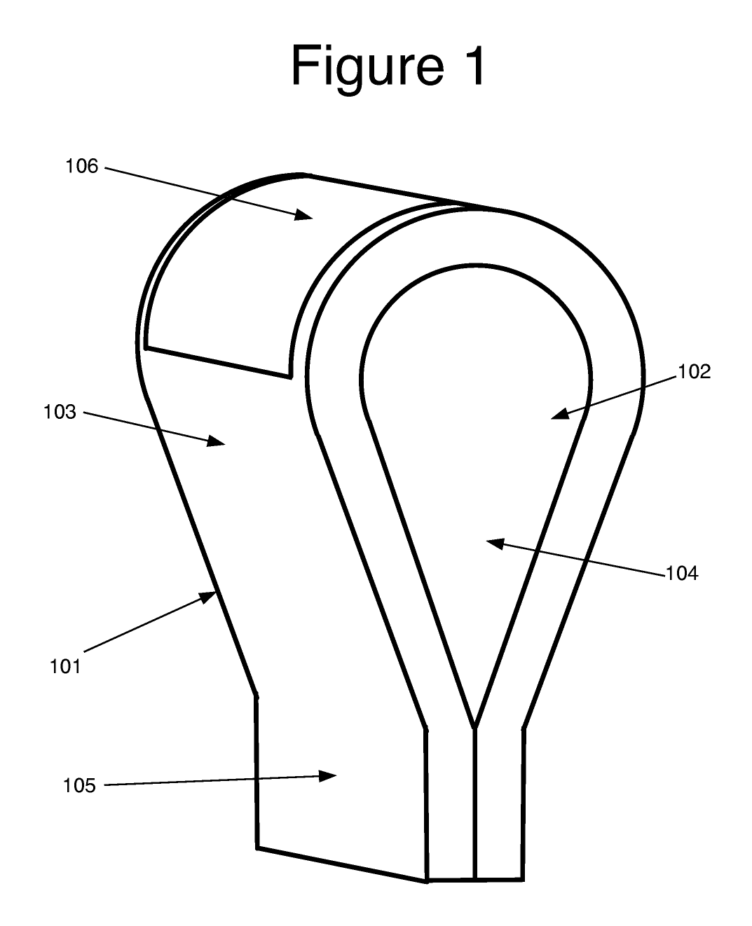

FIG. 2 is a perspective view of another preferred embodiment of the insect capture device.

FIG. 3 is front elevation of a preferred embodiment of a handle for the insect capture device.

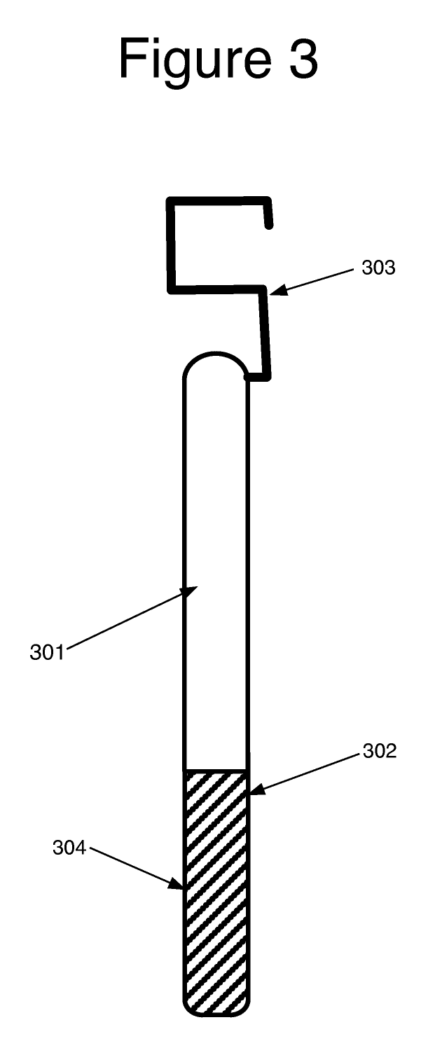

FIG. 4 is another front elevation of the handle as shown in FIG. 3, however this drawing if of a handle without the sleeve portion.

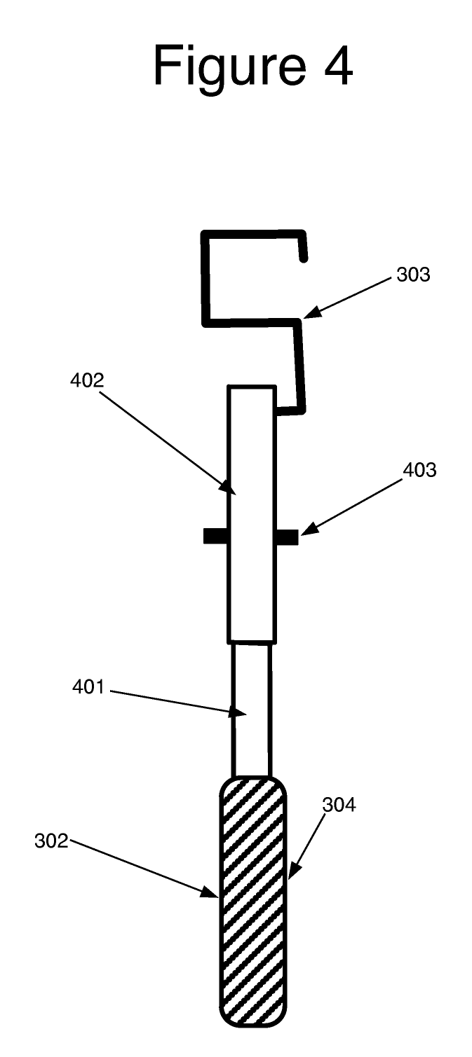

FIG. 5 is a side view of a preferred embodiment of a handle for the insect capture device when extended.

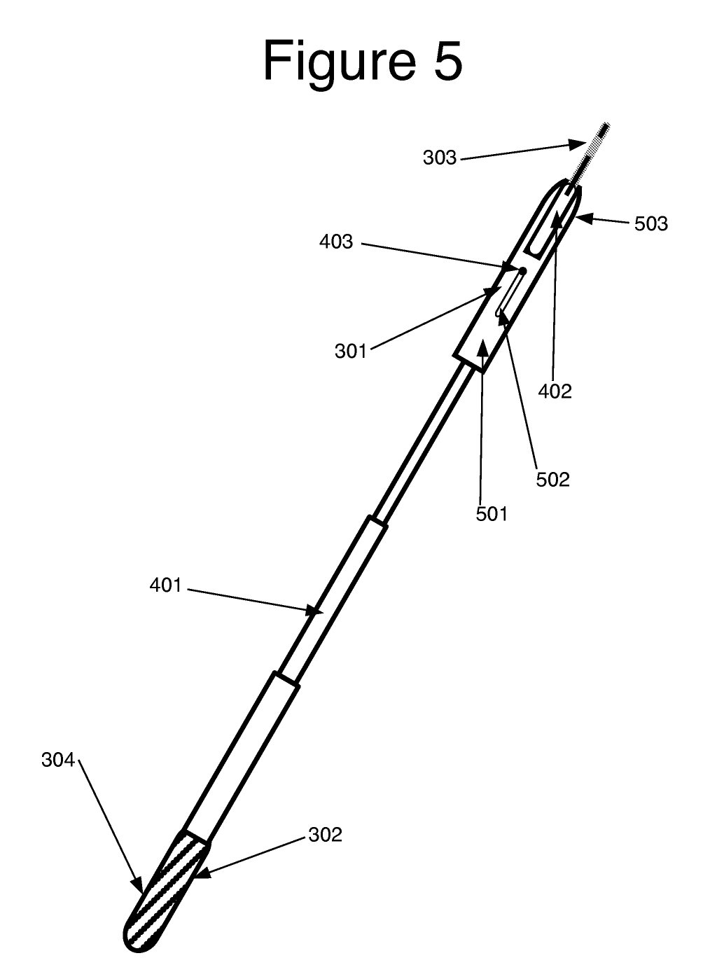

FIG. 6 is a perspective view of a sleeve portion of a preferred handle when it is fully engaged and holding a capture device. The grip portion and most of the telescoping portion of the handle are not shown.

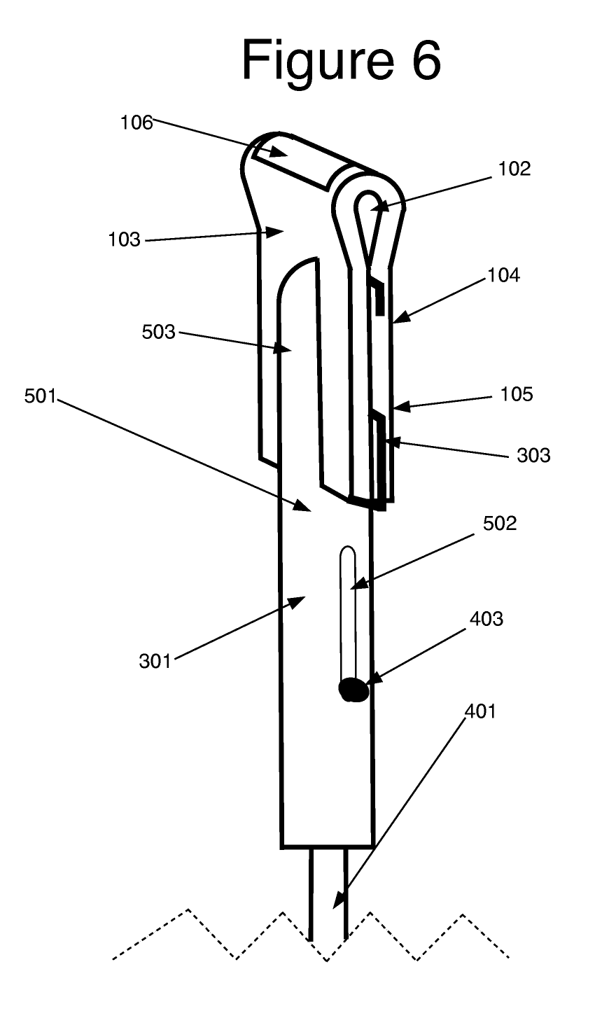

FIG. 7 is a front elevation of an insect capture device as held by a preferred handle when the sleeve portion is fully engaged to hold the capture device. The grip portion and most of the telescoping portion of the handle are not shown.

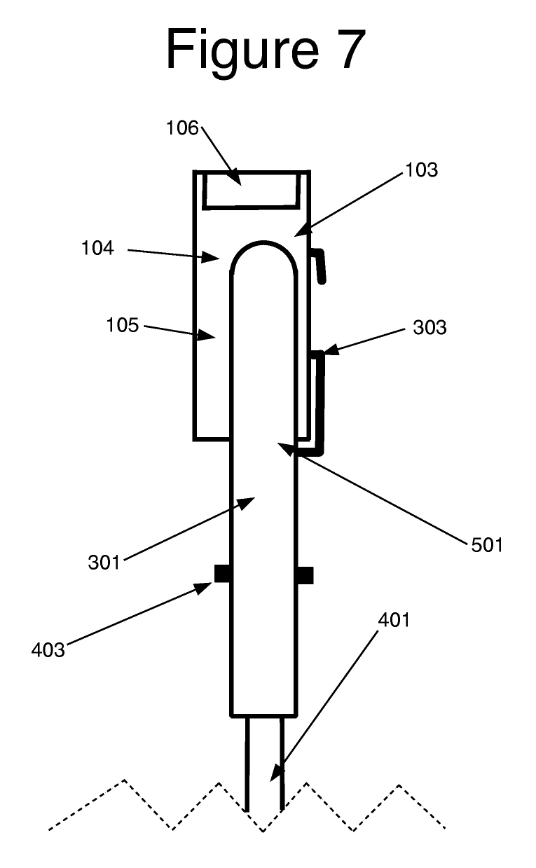

### DETAILED DESCRIPTION OF THE DRAWINGS

The following descriptions and drawings referenced therein illustrate embodiments of the applications subject matter. They are not intended to limit the scope. Those familiar with analogous arts may recognize that other embodiments of the subject matter are possible. All such alternative embodiments should be considered within the scope of the application's claims.

Each reference number consists of three digits. The first digit corresponds to the figure number in which that reference number is first used. Reference numbers are not necessarily discussed in the order of their appearance in the figures.

The application discloses a device suited for the capture of insects and for the retrieval of small objects. The device employs a sticky adhesive to capture the insect and may be reversibly attached to a handle to reach insects or objects out of the user's reach. Use of the disclosed device to capture insects minimizes the possibility of crushing the captured insect, reduces the risk of the sticky adhesive sticking to objects surrounding the insect, and allows the user to maintain a greater distance from the insect than would be achieved by using a piece of material in ones fingertips to grab an insect.

In the preferred embodiment, the insect capture device comprises a hollow structure of a solid foam. In one embodiment, a 25 mm wide, 6 mm thick strip, and 70 mm long strip of solid foam is folded, but not creased, so that the two ends touch and are joined together to form a teardrop shape (101). The capture device has an inner surface (102) and an outer surface (103), as well as a top portion (104) and a bottom portion (105). At least some portion of the outer surface of the top portion comprises a tacky adhesive (106). The area comprising the tacky adhesive may have a release paper or film overlaying it so that the tacky adhesive is not exposed until needed. The solid foam of this embodiment may be polyethylene or other suitable foamed materials.

In one embodiment, the area of tacky adhesive is approximately 20 mm in width and is located centrally on the outer surface of device's top portion. In use, the device is pressed against an insect or other small object so that the tacky adhesive contacts the target. The device may be gripped about the bottom portion by hand, or with the use of a tool such as the handle disclosed herein. The hollow solid foam structure yields as it is pressed against the insect so that the insect is not squashed against the surface where the insect is located. Additionally, as the area comprising the tacky adhesive covers the apex of the outer surface of the top portion of the device, the risk of the inadvertent sticking of the device to the surrounding area is reduced.

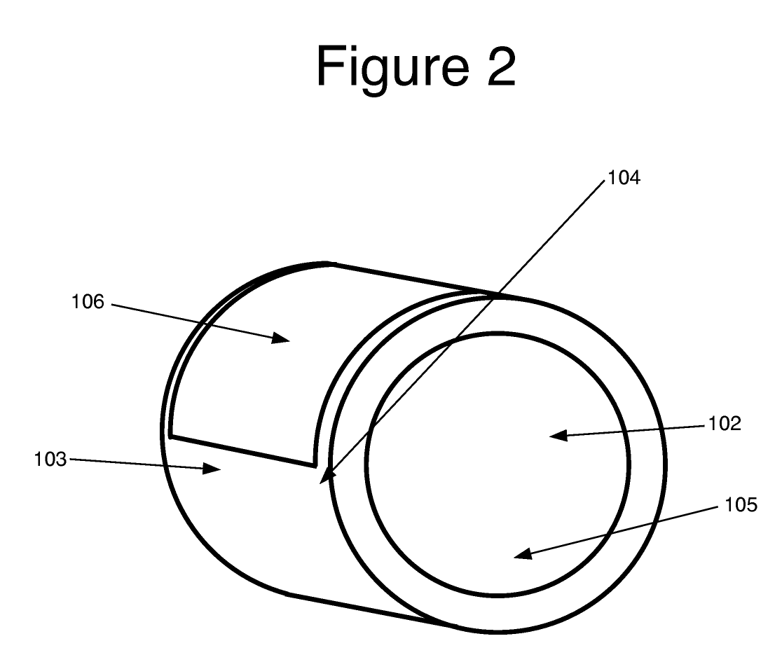

Obviously, the hollow foam structure may be other shapes, including oval, oblong or circular (for example, FIG. 2 illustrates one such circular structure). Also obviously, the hollow foam structure does not necessarily need to be formed by folding a strip of a solid foam. It could be formed, for example, by cutting or machining the appropriate shape from a larger sheet or block of solid foam. For the sake of convenience and clarity, applicant defines an annular ring as comprising the ordinary meanings of an oval, oblong, teardrop, or circular ring. Further, the annular ring foam structure need not form the entirety of the device; rather the annular ring may be attached, or continuous with, a supporting region, such as which may be formed by a block of solid foam material. Also, although a foam structure is preferred, non-foamed materials could be used to form the annular ring. Examples of such non-formed materials include papers or non-foamed plastics.

A further aspect of the insect capture device is a handle comprising a top end (301) and a bottom end (302). Said handle's top portion comprises an attachment means (303) that is capable of being reversibly attached to the insect capture device's said bottom portion. Use of the handle in conjunction with the insect capture device allows for insects or other small objects, out of the user's unaided reach, to be captured.

In one preferred embodiment, the handle is extendable and collapsible to allow for flexibility in how much is withdrawn to reach the target, and to make the collapsed handle more compact so that less space is needed for storage than would be needed for a non-collapsible handle. In one such handle embodiment, the handle comprises a telescopic component (401) that comprises a plurality of sections that can be extended 914 mm in length. The telescopic component can be changed to provide a wider range of lengths.

In one preferred embodiment, the handle comprises a bottom grip portion (304), a telescoping portion (401), a top block portion (402), and a sleeve portion (501). The sleeve portion is approximately the same outer diameter as the bottom grip portion and substantially covers the telescoping portion and top end of the handle when the telescoping portion is in its fully contracted state. The end of the telescoping portion most proximal to the user is attached the bottom grip portion and the end most distal to the user is attached to the said top block portion.

In this preferred embodiment, the top block portion of the handle further comprises an attachment means (303). In one preferred embodiment, this attachment means is an S-shaped hook; in another embodiment, the attachment means may be a hook of an approximate “U” shape. Such hooks may consist of metal, plastic, or other any other suitable material. Other embodiments may use other types of attachment means such as clips, clothes pins, or clamps, among others.

In a preferred embodiment, the top block portion further comprises protrusions (403) or ridges, and the sleeve portion comprises slots (502) or grooves so that the protrusions or ridges align with the slots or grooves. In this embodiment, the sleeve portion is held in place by the top block portion, but the sleeve portion is able to slide across the top block portion in a manner constrained by the relationship of the top block portion's protrusions or ridges with the sleeve portion's slots or grooves.

In a preferred handle embodiment, the top end of the sleeve portion has been machined or formed to provide an opening at the top end (503). The dimensions of the opening and location are complimentary to the hook and allows the hook to recede into the opening when the sleeve is moved distally from the grip portion. In a preferred embodiment, this opening narrows as it reaches its nadir. If the sleeve portion is retracted towards the grip portion, the hook is exposed and can hold one of the insect capture devices. When such an insect capture device is on the hook, extending the sleeve portion in relation to the hook attachment portion, causes the hook, and thereby the insect capture device to be enveloped by the sleeve portion in such a way that the opening of the sleeve portion presses against the insect capture device and holds it in place on the attachment means (303). In one embodiment the sleeve component comprises a rigid plastic material, however the sleeve could comprise any rigid material such as plastics, metals, or combinations thereof.

In one embodiment, the telescopic portion of the handle is constructed out of aluminum and the sleeve constructed out of rigid plastic. However, the handle or its components can be made from other materials such as other metals, plastics, or combinations thereof.

The insect capture device of this invention can take many forms. The major requirement for the insect capture device is that it is compressible, at least some area of the outer surface's top portion comprises a tacky adhesive, and its bottom portion can be gripped by a user's fingers or reversibly attached to a handle.

One process for capturing an insect is for the user to take hold the outer surface of the bottom portion of one of the insect capture devices in one hand, remove the release paper or film (if present) overlaying the tacky adhesive area with the other hand, and extend the outer surface of the top portion towards an insect so that the tacky adhesive of the insect capture device contacts and adheres to the insect.

Another process for capturing an insect, and one that makes use of the optional handle, is to start with the handle in closed position: the extendable portion at, or near, its minimum dimension, and the sleeve portion retracted towards the grip portion. The insect capture device is then placed so that the hook penetrates into the hollow region of the device. The sleeve portion is then slid away from the grip portion causing the bottom portion of the insect capture device to be forced into the opening of the sleeve component. The sleeve portion is moved distal from the grip portion until the insect capture device is sufficiently inserted to be held in place by the hook and the sleeve portion. The release paper or film located on the top surface of the insect capture device is then removed, and the length of the handle adjusted using the telescopic component of the handle. The tacky portion of the insect capture device is then brought into contact with the insect to capture it. To remove the device and captured insect, the sleeve component is moved towards the grip portion, releasing the device from the opening of the sleeve. If desired, the handle is rotated so that gravity causes the device to fall off the hook.

I claim:

1. A device for the seizure of insects and other objects comprising an annular ring having an inner surface and an outer surface, and further having a top portion and a bottom portion, wherein said top portion's outer surface comprises an area comprising a tacky adhesive.

2. The device of claim 1, wherein said annular ring is formed by a flexible strip of material.

3. The device of claim 1, wherein said annular ring comprises a solid foam material.

4. The device of claim 2 wherein said flexible strip of material comprises a solid foam material.

5. The device of claim 1, further comprising a handle comprising a means of reversibly attaching to said annular ring's said bottom portion.

6. The device of claim 2, further comprising a handle comprising a means of reversibly attaching to said annular ring's said bottom portion.

7. The device of claim 3, further comprising a handle comprising a means of reversibly attaching to said annular ring's said bottom portion.

8. The device of claim 4, further comprising a handle comprising a means of reversibly attaching to said annular ring's said bottom portion.

9. The device of claim 5, wherein said handle is extendable.

10. The device of claim 6, wherein said handle is extendable.

11. The device of claim 7, wherein said handle is extendable.

12. The device of claim 8, wherein said handle is extendable.
